(19) United States
(12) Patent Application Publication
(10) Pub. No.: US 2005/0200465 A1
(43) Pub. Date: Sep. 15, 2005

(54) Child seat occupancy alarm system for automobiles

(76) Inventors: Shawn O'Brien Fabors, Plano, TX (US); Robert Keith Eschler, Plano, TX (US); Marcus Lemon Cooper, Sachse, TX (US)

Correspondence Address: SHAWN FABORS, 3016 MILL RIDGE DRIVE, PLANO, TX, 75025, US

(21) Appl. No.: 10/801,162

(22) Filed: Mar. 15, 2004

(51) Int. Cl. B60Q 1/00

(52) U.S. Cl. 340/457; 340/584; 340/667

(57) ABSTRACT

The present invention, is an alarm system for detecting the presence of a child being left unattended in a car seat inside a parked vehicle. The alarm includes a weight sensor and temperature monitoring device. The weight of the child activates the unit, which then begins monitoring the interior temperature of the vehicle. Should both the car seat be occupied and the interior temperature reach pre-determined danger levels, an alarm will be triggered.

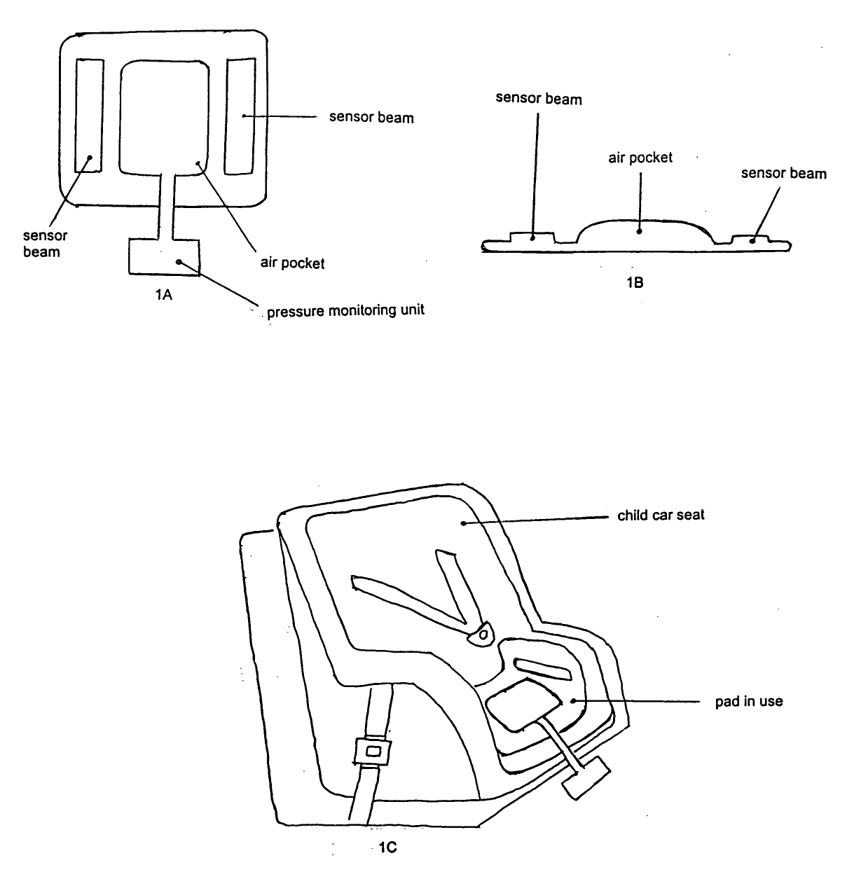

### CROSS-REFERENCE TO RELATED APPLICATIONS

Various devices have been invented to detect the presence of a child in an unattended or parked vehicle, however they require either the user to install motion detecting equipment, attach vital function monitoring devices to the child, or they are only used to indicate the presence of a child while in operation or during an accident. For example U.S. Pat. No. 5,793,291 is a motion detecting device, which monitors the interior temperature of the vehicle. In the event, an operator of the vehicle locks a child or animal in a parked car and temperatures reach life threatening levels an alarm is triggered. Although the benefits are the same, this invention requires installation of motion sensors as well as requires movement of the child/animal to activate the alarm. It is not mobile to alternate vehicles or car seats as intended in my invention. Another similar invention is U.S. Pat. No. 6,393,348, which monitors the vital function of the child. This device monitors and relays vital functions of the child to a receiver. This device was developed to promote safer driving, by monitoring the vital functions of a child placed in the back seat of a vehicle, whereby allowing the driver to view the vital functions of the child while driving. It requires direct attachment to the child and only detects when vital functions are outside of a pre-determined range. By the time vital functions reach danger levels to trigger an alarm, a child left in a parked vehicle could suffer health damages if not death before being rescued. Another similar device is U.S. Pat. No. 5,260,684, which detects the presence of an infant in a vehicle, however this is only for use while in operation or after being involved in an accident. This system brings awareness of a child on board while in operation and allows for the location of the child after an accident. It does not provide a mechanism to detect and monitor the interior temperature of a vehicle should a child be left in a vehicle during life threatening temperatures.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

This invention is directed to an alarm system used in-conjunction with a car seat to alert when a child has been left inside a vehicle during life threatening temperatures.

Studies and actual events have proven that infant and/or child safety seats should not be placed in the front seat of a vehicle, especially those equipped with a passenger side airbag. This of course has lead to concerned parents placing their children in the rear seat of their vehicle. Given today's hectic schedule of two working parents, placing a child in the rear seat often times means out of sight, out of mind. One child being left unattended in a vehicle during life threatening temperatures is too many. News publishing's have suggested placing something you need that day for work by your child. How many times has someone gone off and forgotten needed work items in their car or at home. To rely on this method of safety for a child is unacceptable.

### BRIEF SUMMARY OF THE INVENTION

The device is an alarm system used in conjunction with a car seat, which alerts when a child has been left in a vehicle during life threatening temperatures.

### BRIEF DESCRIPTION OF THE SEVERAL VIEWS OF THE DRAWING

1A This view depicts the pad laying flat, from a top view looking down. It shows the optional sensor beams on the left and right side, with the air/gel filled pocket in the middle with a lead tube and wire harness exiting to the pressure monitoring unit.

1 B This view depicts the pad laying flat, from a horizontal view, to display the thickness and portability of the device.

1C This view depicts the pad in use with a car seat.

### DETAILED DESCRIPTION OF THE INVENTION

The device is child occupancy alarm system for automobiles. It consists of a flexible rubber pad containing an air filled pocket, a pressure monitoring unit, sensors, and a temperature monitoring apparatus. The pad lays in the seat of a child's car seat underneath the child, between the child and the car seat. The weight of the child forces said air into a pressure monitoring unit activating the system after a programmable amount of time has elapsed. This delay allows the interior temperature of the vehicle to reach normal operating temperatures. Once activated the temperature monitoring device will begin to monitor the interior temperature of the vehicle as long as the car seat is occupied. Should the child be left inside a parked vehicle and the temperature reach pre-determined danger or life threatening temperatures, an alarm will be triggered.

1. A child vehicle safety device usable in-conjunction with a child's car seat, which includes a system to monitor the interior temperature of a vehicle should a child be left in the vehicle during life threatening temperatures comprising:
a) the device will consist of a flexible rubber pad, positioned in a car seat underneath the child between the child and the car seat
b) the device is weight activated, whereby the pad will contain an air filled pocket, the weight of the child will force the air out of the pocket and into a pressure monitoring unit, activating the device
c) the device may also contain confirmation devices comprising of
i) at least two sensor beams, whereby placing the child into the seat and onto the pad will break the sensor beams confirming the seat is occupied
ii) wire connectors attached to the seat belt, whereby completing the circuit once the child is placed in the car seat and the seat belt is fastened
d) the device will contain a temperature monitoring unit, which will monitor the interior temperature of the vehicle
e) the device will contain an alarm mechanism, which will be triggered should the interior temperature of the vehicle exceed or fall below the predetermined temperature while the car seat is occupied

2. The invention cited in claim 1 will turn itself on and off based upon the car seat being occupied; and the required amount of pressure being received by the pressure monitoring unit

3. The invention cited in claim 1 will have an indicator light alerting whether the device is activated

4. The invention cited in claim 1 will begin to monitor the interior temperature of the vehicle after a programmable amount of time has expired allowing the interior temperature to reach normal/safe temperatures

5. The invention cited in claim 1 can have power sources comprising:
a) independent battery power, separate from the vehicle battery, with low battery indicator
b) directly to the vehicle or alternate power such as a cigarette lighter

6. The alarm cited in claim 1 can comprise of:
a) bright light or signal, clearly visible to anyone outside of the vehicle within a reasonable distance;
b) high pitched siren or vehicle's car horn
c) transmitting unit, capable of transmitting signals to:
i) a receiver located at a monitoring center, law enforcement agency, or emergency rescue agency
ii) portable or permanent GPS system
iii) portable receiver capable of being kept on guardian of the child

7. The invention recited in claim 1 wherein said pad is detachable from the car seat and universal with all types of car seats and bolster seats

8. The invention recited in claim 1 whereby the device is portable allowing it be transported to other car seats or vehicles. Future models can require the device to be built directly into the manufacturing of the car seat

9. The invention in claim 1 may also contain physical deactivation devices comprising of:
a) reset switch attached directly to the system
b) remote deactivation
